(19) United States
(12) Patent Application Publication
(10) Pub. No.: US 2024/0253241 A1
(43) Pub. Date: Aug. 1, 2024

(54) CONSTRUCTION ROBOT

(71) Applicant: TX Bridge Robotics, INC., Miami, FL (US)

(72) Inventors: Carlos Fernandez Lillo, Miami, FL (US); Gabriel Maria Jimenez Lopez Alegria, Miami, FL (US)

(73) Assignee: TX Bridge Robotics, INC., Miami, FL (US)

(21) Appl. No.: 18/161,154

(22) Filed: Jan. 30, 2023

(51) Int. Cl. B25J 11/00; B25J 5/02; E01D 21/00

(52) U.S. Cl. CPC B25J 11/0055; B25J 5/02; E01D 21/00

(57) ABSTRACT

Construction robot, for the construction of bridges, formed by a motorized chassis (4) and configured to run longitudinally along a beam (1) with a geo-positioning system (7) and one or more height-adjustable cutting tools (8) arranged over at least one edge of the beam (1). The cutting tools (8) vary the height according to the position of the robot.

### FIELD OF THE INVENTION

A construction robot specially designed for the construction of bridges is proposed. It is configured to run along the deck-support beams to carry out preparatory work for the placement of slabs between the beams.

### BACKGROUND OF THE INVENTION

A bridge construction method is known in the state of the art in which several I-beams are placed in parallel, two strips of high-density foam are placed on their edges and some slabs are supported on the foam strips to form the bridge deck. An example of this bridge construction method is seen in U.S. Pat. No. 6,568,139B2 (incorporated herein by reference).

One of the problems with this method is that the foams have to be very precisely placed according to the actual final position of the beams. A method for placing bridge beams with high precision is known from WO2022114385. This method is insufficient to ensure the perfect positioning of the slabs. Any small error in the position of the beams must still be absorbed during the placement of the foam strips.

In actual practice, once the beams have been positioned, some workers must go through the beams lengthwise, placing the foam strips in the exact position and cutting their height if necessary. This involves a large amount of labor and time and, above all, a high risk of accident due to working at heights and on narrow structures. It is necessary to reduce this risk of accident, improve the construction time and the accuracy in the positioning of the slabs.

The applicant is also aware of GB2585534 and CN112411385, which are of lesser relevance. The applicant is not aware of any solution equivalent to the one claimed.

### SUMMARY OF THE INVENTION

Due to all this, a construction robot is proposed that allows for the safe construction of bridges of the type defined in the cited patent.

The beams that form the bridges in which the invention is applied are usually of the I type. However, it has to be considered that the robot is applicable on any beam with a substantially horizontal upper part. In the figures I-beams have been shown, but the beams of the invention may be of square section, T beams, C beams.

The construction robot, for the construction of bridges, is made up of a motorized chassis configured to run longitudinally along a beam. The robot has a geo-positioning system and one or more (usually two) height-adjustable cutting tools. Each cutting tool is arranged over one longitudinal edge of the beam, where the foam strip will be placed. The robot is configured to vary the height of each cutting tool based on the position of the robot. To do this, it compares its real position with the theoretical one, adjusts the height of the foam strip at each point, so that the slabs that close the space between the beams are in the correct position.

Other variants and embodiments will be appreciated in the remainder of the specification.

### BRIEF DESCRIPTION OF THE DRAWINGS

To complement the description below and in order to provide a better understanding of the invention, a set of drawings is attached as an integral part of said description according to a preferred example of its practical embodiment. In those drawings, with an illustrative and non-limiting nature, the following has been represented:

FIG. 1 is a front view of an example of a bridge where the robot is applicable, according to U.S. Pat. No. 6,568,139B2;

FIG. 2 is a perspective schematic view of an embodiment of the robot;

FIG. 3 is a detailed of the view of the robot of FIG. 2;

FIG. 4 is a detailed view of FIG. 2, with elements removed to appreciate the lower part of the robot; and

FIG. 5 is a front view of the previous example.

### PREFERRED EMBODIMENT OF THE INVENTION

FIG. 1 shows a schematic of a bridge where the invention is applied. It can be seen that the bridge has a series of beams (1), with a substantially horizontal upper surface (11) from which some reinforcement bars (12) usually protrude. Between two adjacent beams (1) there is a slab (2) resting on the upper surface (11) of both beams (1). The support of the slab (2) on each beam (1) is carried out by separate foam strips (3) of high-density foam. More details about this type of bridges can be seen in U.S. Pat. No. 6,568,139B2.

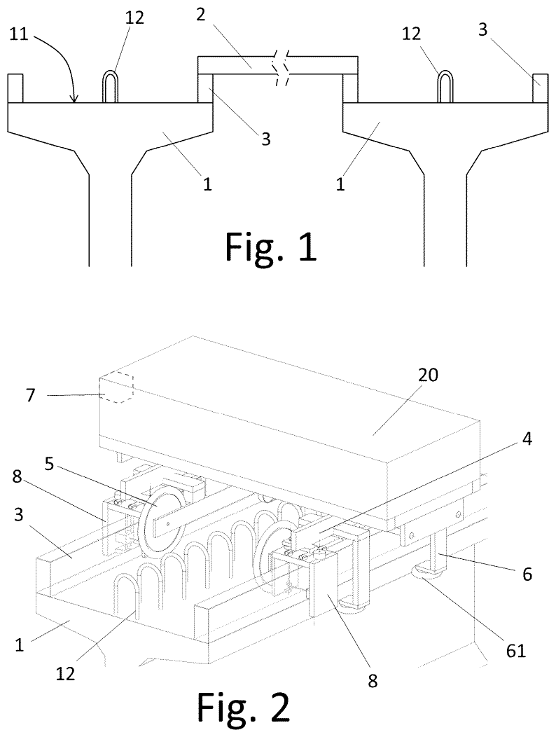

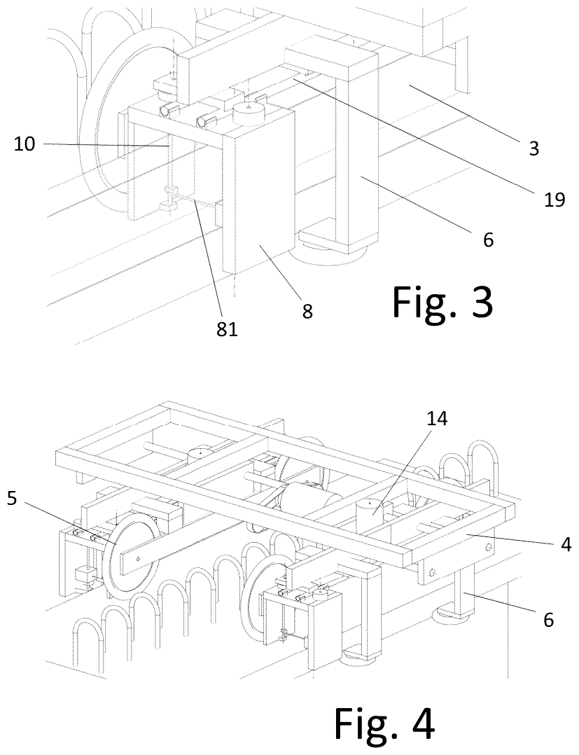

FIG. 2 shows an example of a robot according to the invention. This robot has a chassis (4) on wheels (5). The chassis (4) is arched to allow the reinforcement bars (12) to pass through. One or more of the wheels (5) is motorized to propel the robot along the beam (1), in one direction or another. Some lateral stops (6) contacting the sides of the beam ensure that the robot does not fall off the beam (1). The stops (6) may have auxiliary wheels (61). The chassis (4) can be extensible in one direction to adapt to different beam (1) widths, although these are usually standard. The figures show some guides (61) on which the stops (6) are placed to adjust their mutual spacing to the actual width of the beam. The stops (6) can be replaced by sensors that detect that the robot is centered. An example of these sensors are ground clearance meters. When the distance increases on one side, it is understood that the robot is moving towards that side and that is why the sensor detects the distance to the ground or another element instead of the upper surface (11).

The robot has a geo-positioning system (7). This geo-positioning system (7) can be a GPS, a system of radio beacons, a survey prism on the robot in combination with a total station for providing coordinates or any other high-precision system, as a 3D survey scanner to have the real elevation of the beam at each position of the robot. This geo-positioning system (7) will make it possible to compare the position of the robot on the theoretical position of the beam (1). For example, using a BIM (Building Information Modeling) database can be used to find out the theoretical position of the beam (1) in the bridge construction plans, or any other model may be used to calculate the theoretical position.

The robot has at least one cutting tool (8) for the foam strips (3). The cutting tool (8) can be one or more cutting lasers, one or more drill cutters or another method. Preferably it is a metallic hotwire (81), for example connected to an electrical circuit for heating. An ejector (9) can be provided which pushes the cut part of the foam strip (3) to one side. Preferably, towards the center of the beam (1) so as not to make materials fall to the ground from the top of the beam. An example of an ejector (9) is a protrusion from the top or side of the chassis (4). A second example is a hydraulic or pneumatic cylinder that pushes the surplus. The cutting tool may be movable along a guide (19) so it can be placed on either end of the robot. This allows the robot to cut the foam at both ends of the beam (1). Instead of advancing the robot, the cutting tool (8) advances on the robot.

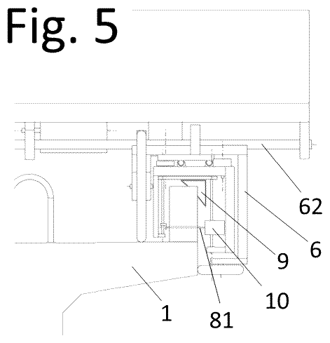

The cutting tool (8) is arranged in a height-adjustment device (10), such as an extensible arm by a scissor mechanism or a carriage movable along an auger (FIG. 5).

The height-adjustment equipment (10) will be commanded by a motor (14), preferably a step-by-step motor to increase precision. The height-adjustment equipment (10) may have buttons or sensors that help in its calibration. For example, it can have a series of photoelectric cells that detect the passage of the cutting tool (8) through various heights and recalculate the relationship between the height-adjustment equipment (10) and the cutting tool (8) actual position. The ejector (9) can move in coordination with the cutting tool (8) so that it is always above the cutting line.

If the robot has a single cutting tool (8), when the operation starts in one of the extremes of the beam, the cutting tool will start cutting and will move along the upper rail (4) going from the back of the robot (cutting start position) all the way to the front of the robot (normal position of the cutting tool). In any case, each cutting tool (8) can be at a different height for the same position of the robot, depending on the position and angle of the beam (1).

A control unit (20), which can be remote, compares the position of the robot with the theoretical position, in all the coordinates of space. From that difference, it calculates the height of the foam strip (3) at each point and commands the cutting tool (8) to remove the excess. In its operation, the robot advances at a controlled speed while adjusting the height of each cutting tool (8).

The foam strip (3) can be placed by a similar robot, once the beam (1) is located in height. However, it is preferably placed at the edges of the beam (1) before it is hoisted. In this way, the presence of an operator on the already-raised beam (1) is not necessary. Most of the operations are done on the ground or by robots.

Ideally the foam strip (3) is of a height greater than the possible error, so that the robot always has to cut, since adding more foam strip (3) is considerably more complicated than cutting it.

The robot can be powered from the base, by a cable, but preferably it has its own battery to be autonomous.

1. A construction robot for construction of bridges comprising:
a motorized chassis (4) configured to run along a beam (1),
a geo-positioning system (7); and
at least one cutting tool (8) adjustable in height arranged over at least one edge of the beam (1) and
wherein a height of each cutting tool (8) is adjustable according to the position of the robot.

2. The construction robot according to claim 1, further comprising lateral stops (6) contacting the sides of the beam (1).

3. The construction robot according to claim 1, wherein the cutting tool (8) is a hot wire (81), a laser beam, or a milling tool.

4. The construction robot according to claim 1, wherein the cutting tool (8) is mounted on a carriage movable along an auger or tampering system, to move up and down the cutting tool (8).

5. The construction robot according to claim 1, further comprising an ejector (9) after the cutting tool (8).
